(19) United States
(12) Patent Application Publication
(10) Pub. No.: US 2005/0139526 A1
(43) Pub. Date: Jun. 30, 2005

(54) Method for processing mass mailings and device for carrying out said method

(76) Inventor: Wolf-Stephan Wilke, Konstanz (DE)

Correspondence Address: Philip G Meyers;Intellectual Property Law, 1009 Long Prairie Road #302, Flower Mound, TX, 75022, US

(21) Appl. No.: 10/508,962

(22) PCT Filed: Mar. 17, 2003
(86) PCT No.: PCT/DE03/00851

(30) Foreign Application Priority Data
Mar. 30, 2002 (DE) 102 14 452.4

(51) Int. Cl. B07C 5/00

(52) U.S. Cl. 209/584

(57) ABSTRACT

The invention relates to the processing of mass mailings, using sorting machines consisting of at least one input of material and one distributor device for distributing mailing items to distribution points according to distribution information. The individual mailing items (1) making up a mass mailing are shrink-wrapped by the sender in strips of film (4,5), collectively forming a bag strip and being jointly dispatched in the form thereof. The bag strip is introduced into the sorting machine at the respective destination point via a material input conveyor device (10). A separating device (15) is then used to separate the film bags (8) from each other. An acceleration device (16) is subsequently used to produce gaps between the film bags (8) for further processing.

The invention relates to a method for processing mass mailings according to the preamble of claim 1 and a device for carrying out said method.

Mass mailings (in particular those in large format) have hitherto usually been supplied as individual items in bound form (what are known as “bundles”), for example with plastic film or tape) (cf. DE 30 15 829 C2, EP 0 303 203 A2). This form of supply is relatively well suited to subsequent manual processing (for example walksorting by the mailman).

Furthermore, mass mailings (journals, brochures, mailshots) are often of qualities which are difficult to process by using known feeder technology (damage to the mailing, adhesion to one another and in the feeder).

During processing of mass mailings supplied in this way in sorting machines, the following, complicated (personnel-intensive) sequence of operations is necessary:
breaking open the bundle,
preparing the mailings for processing by machine (rotate to address field, stack, align),
placing the mailings on the material input for separation,
monitoring the running of the mailings at the feeder and, if necessary, eliminating faults.

The invention is therefore based on the object of providing a generic method for processing mass mailings and a device for carrying out said method which considerably reduce the expenditure on personnel as compared with the prior art and with which the separation of the mailings in the sorting machine can be carried out more simply and more securely.

According to the invention, the object is achieved by a method as claimed in claim 1 and a device as claimed in claim 8.

The individual mailings of the mass mailing are shrink-wrapped in strips of film, hanging together to form a strip of bags. The mailings are then dispatched hanging together in this way. At the respective destination, the strip of bags with the mailings is drawn into the material input to the sorting machine by a transport device. After that, the film bags with the mailings are separated from one another by means of a cutting device. Then, by means of an acceleration device, the gaps between the film bags necessary for the further processing in the sorting machine are produced. It is therefore merely necessary for the start of the strip of compartments with the mailings to be introduced into the material input to the sorting machine in a single manual operation. The separation is then carried out in a secure and uncomplicated manner and considerably more economically than by using conventional frictional separators. Substantially higher throughputs are also possible.

Advantageous refinements of the invention are presented in the subclaims.

Thus, it is advantageous at the sender to guide the mailings one after another between two endless film strips unwound from rolls and belonging to a packaging device, in which they are completely shrink-wrapped without subdividing the film strips.

For the transport, it is advantageous to transport the shrink-wrapped mailings hanging together in fan-fold form in appropriate containers or in roll form.

For secure threading of the films into the material inputs of the sorting machines, it is advantageous to provide the strip of bags with perforations at the sides and to equip the threading transport devices with transport gear wheels which engage in the perforations. In order that the mailings reach the recipient in the original state, it is advantageous to provide each film bag with an address sticker or imprint after shrink-wrapping. If the recipient addresses are located directly on the mailing, it is advantageous to design the film to be transparent.

In the following text, the invention will be explained in more detail in an exemplary embodiment by using the drawing, in which:

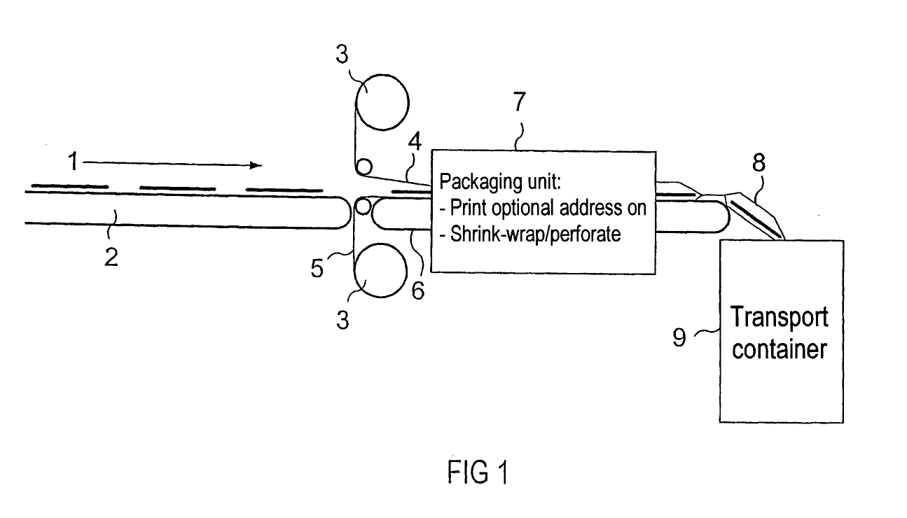

FIG. 1 shows a schematic side view of an arrangement for producing the mailings located in film and connected to one another,

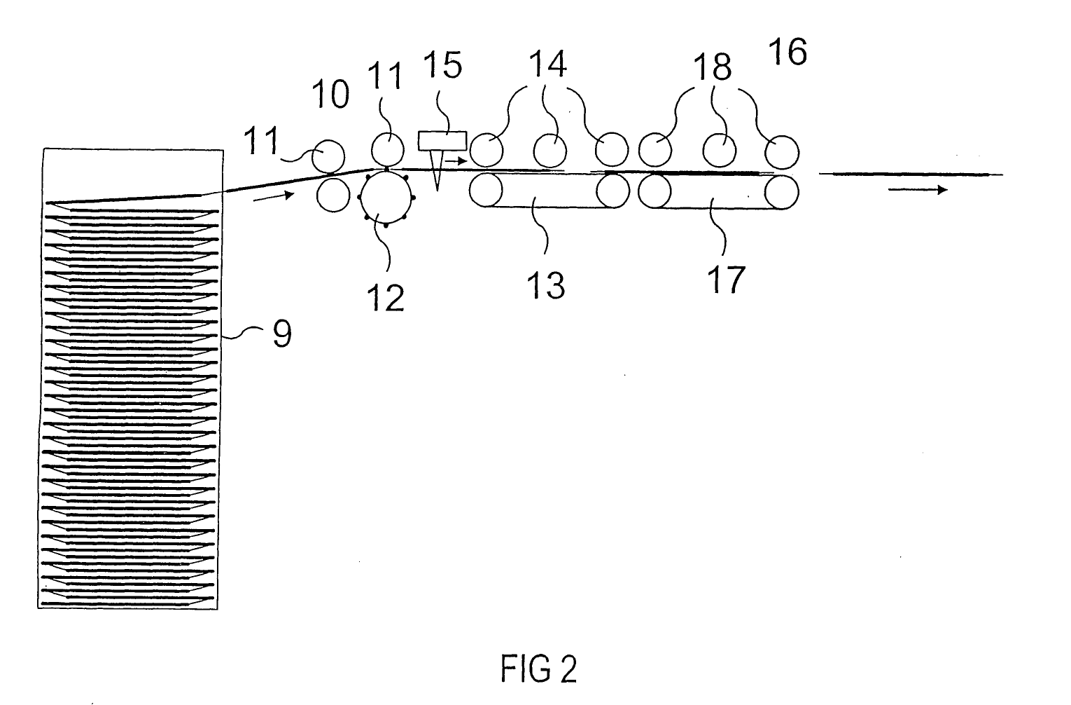

FIG. 2 shows a schematic side view of a container having mailings stored in fan-fold form and of the threading of the mailings into a material input of a sorting machine.

As FIG. 1 illustrates, at the sender the individual mailings 1 of the mass mailing are supplied on a first conveyor belt 2 to a packaging module known per se. The latter has two rolls 3 with strips of film 4, 5. The film strip 5 from the lower roll 3 is led directly to a further, second conveyor belt 6 picking up the mailings 1 from the first conveyor belt 2, so that the mailings 1 lie on the lower film strip 5 and are transported through the packaging unit 7. The film strip 4 from the upper roll 3 is led over the lower film strip 5, covering the mailings 1, and in the packaging unit 7 the film strips 4, 5 are then welded around each mailing 1, so that, as a result, film bags 8 connected to one another and having mailings leave the packaging unit 7 and are then deposited in a transport container 9 in fan-fold form. In the packaging unit 7, the bags 8 with the mailings 1 are provided with address imprints, the addresses being taken from a corresponding file. It is also possible to supply this file at the destination as well or to transmit it to said destination and only to apply the addresses in the sorting machine.

In order to make it easier to process the connected film bags at the destination, the film strip with the bags 8 is provided with perforations on both sides in the packaging unit 7. At the destination, the first bag 8 of the bags 8 of the mass mailing stored in fan-fold form in the transport container 9 is introduced manually into the material input of a sorting machine and the further sequence is then carried out automatically.

FIG. 2 illustrates schematically how the threaded strip of bags is treated in the material input of the sorting machine.

At the entry to the material input, there is a transport device 10, comprising transport rolls 11 with an elastic surface and transport gear wheels 12 that engage in the lateral perforations. Therefore, the strip of bags from the transport container 7 is threaded into the sorting machine and picked up by a transport belt 13 having pressure rollers 14. The transport container 9 can also be set up at an angle or horizontally, in order for example to reduce the weight acting on the strip of bags. The mailings can be contained in the strip of bags aligned either in the transverse or in the longitudinal direction in relation to the direction of the strip. The transport speed is set such that it is coordinated with the subsequent processes and ensures high process reliability. Between the two transport devices there is a separating device 15, with which the strip of cohering bags 8 is subdivided into individual bags 8 at right angles to the direction of the strip. The separating device 15 in this example is a cutting device having a movable cutting knife. The control of the separating device can be carried out simply with the aid of control marks located on the edges of the film strip and sensors detecting said control marks in order to trigger the cutting movement. In order that the film strip is tautened under tension during cutting, the transport speed of the transport belt 13 is somewhat higher than the transport speed of the threading transport device 10. The moving cutting knife can be a rotating knife roll or a knife moved to and fro. However, thermal separating devices or a laser can also be used.

The individual bags 8 are then supplied by the transport belt 13 to an acceleration device 16, comprising an acceleration belt 17 and pressure rollers 18. Here, acceleration takes place to a briefly higher transport speed than in the preceding and following subassemblies, in such a way that a minimum gap between the bags, necessary for the further processing in the sorting machine, is maintained. If necessary, a plurality of acceleration belts can also be arranged one after another.

1. A method for processing mass mailings by using sorting machines which have at least one material input and a distributing device for distributing the mailings at distribution points in accordance with the distribution information, characterized in that the individual mailings of a mass mailing are shrink-wrapped at the sender in strips of film, hanging together to form a strip of bags, are dispatched hanging together in this way in a strip of bags and, at the respective destination, are threaded as a strip of bags into the sorting machine by a transport device belonging to the material input, and are then separated from one another by means of a separating device, and in that, after that, by means of an acceleration device, the gaps between the film bags necessary for the further processing in the sorting machine are produced.

2. The method as claimed in claim 1, characterized in that, at the sender, in order to produce a strip of bags, the mailings of the mass mailing are led one after another between two endless film strips, unwound from rolls and belonging to a packaging unit, in which they are shrink-wrapped completely without subdividing the film strips.

3. The method as claimed in claim 1, characterized in that the shrink-wrapped mailings hanging together are stored in fan-fold form in appropriate transport containers and are transported to the destination.

4. The method as claimed in claim 1, characterized in that the shrink-wrapped mailings hanging together are stored in roll form and are transported to the destination.

5. The method as claimed in claim 1, characterized in that the strip of bags with the shrink-wrapped mailings is provided with perforations at the sides, and the threading transport device of the material input of the sorting machines has transport gear wheels which engage in the perforations.

6. The method as claimed in claim 1, characterized in that, following shrink-wrapping, each film bag is provided with an address sticker or imprint.

7. The method as claimed in claim 1, characterized in that transparent films are used.

8. A device for carrying out the method as claimed in claim 1, characterized in that the material input of the sorting machines has a transport device for threading the strip of bags with the shrink-wrapped mailings, a separating device for dividing up into individual film bags having mailings, and an acceleration device for producing the gaps between the film bags necessary for the further processing in the sorting machine.

9. The device as claimed in claim 8, characterized in that the threading transport device of the material input of the sorting machines has transport gear wheels which engage in lateral perforations in the strip of bags.
